(19) United States
(12) Patent Application Publication
(10) Pub. No.: US 2009/0231485 A1
(43) Pub. Date: Sep. 17, 2009

(54) Mobile Terminal Device, Dongle and External Display Device Having an Enhanced Video Display Interface

(76) Inventor: Bernd Steinke, Ludenscheid (DE)

Correspondence Address: Hollingsworth & Funk, LLC, 8009 34th Avenue South, Suite 125, Minneapolis, MN, 54425, US

(21) Appl. No.: 12/439,786

(22) PCT Filed: Sep. 6, 2006
(86) PCT No.: PCT/IB06/02469

§ 371 Date: May 20, 2009

(51) Int. Cl. H04N 11/02

(52) U.S. Cl. 348/425.1; 375/240.01; 348/E11.006

(57) ABSTRACT

The present invention relates to the field of mobile terminal devices, dongles and display device connected with external displays for mobile terminals. A mobile terminal device comprises a processing unit having the capability to process high resolution display content, a user interface comprising at least a low resolution display, connected to said processing unit to display low resolution display contents, and a video display interface connected to said processing unit, said display interface having high resolution display contents transferring capabilities to provide said high resolution display contents from said processing unit, wherein said mobile terminal device comprises high resolution display contents compression capabilities to reduce the data rate of said high resolution display contents, and a serial bus connector to transfer said high resolution display contents having a reduced data rate to an external display device. The invention also relates to other embodiments of this device, a connectable display and a display adapter to connect a conventional display to the mobile terminal.

The present invention relates to the field of mobile terminal devices and the use of external display devices in connection with mobile terminals. The present invention also relates to the technical field of mobile telephones, video signal conversion and displays connectable to mobile terminal devices. It also relates to the enhancement of display interfaces for mobile devices with a minimized use of proprietary interface technology. The invention also relates to a dongle enabling to use large displays with mobile terminals without the use of conventional display interface in the mobile terminal device. The present invention is also related to video and display interface technology of quasi-static images as used e.g. in PC office applications or collage based animated videos/movies.

Presently it is not possible to use miniature mobile devices such as e.g. mobile telephones and player devices in connection with large displays as the overall size of such miniature devices is restricted. To enhance the operability of such small mobile devices, it may be desirable to use highly integrated and computational powerful devices such as mobile phones for additional technical implementations and other applications than just phoning.

However, there is a significant restriction limiting the size of a mobile telephone with respect to the usability and operability. Presently the minimum size of a mobile device is restricted by size of the user interfaces (buttons and display) so that the operation and input is simple enough to be performed with average size fingers and average quality eyes. On the other hand the time of brick size (and weight) mobile terminals or mobile phones definitively has passed. That is, increasing the device size (and partly also the weight) to increase the operability is also not desirable for a true mobile device, since it limits the mobility and the handling of the mobile device.

To enhance the operability of the phone it is also not helpful to increase the resolution of the display (more dots per inch—dpi) as the angular resolution of the human eye is limited. The human eye has a resolution of roughly 0.1 mm at a distance between 25 cm and 50 cm; there is no sense in increasing the display resolution beyond the resolution of the human (except for the reasons of suppressing moiré). There is also no sense in decreasing the distance between the eye and the phone, as the minimum distance is limited by the accommodation capabilities of the human eye. There doesn't seem to be much use for an ultra resolution display used in combination with a kind of magnifying glasses, screen magnifiers or Fresnel lenses, either.

Presently, there are no solutions that introduce additional capabilities to small mobile devices because of the display size limitations caused by the device size limitation of small, handy mobile devices. This limitation prevents e.g. the use of electronic books in connection with mobile telephones. The lack of sufficient user input interfaces prevents the use of e.g. text processing in connection with small, handy portable devices having the size of a mobile phone.

These limitations prevent that e.g. computer desktop graphical interfaces (such as e.g. PC desktops) may be displayed onto the screen of a mobile device (as it would not longer be possible to recognize e.g. the icons in the task bar). That is, presently there is no technical way to display a desktop of all information for text reading, text processing or word processing into the handy mobile terminal devices.

Conventional video interfaces such as Sub-D (D shaped sub miniature connector), SCART (Syndicat des Constructeurs d'Appareils Radiorécepteurs et Téléviseurs), DVI (Digital Video Interface) and HDMI (High Definition Multimedia Interface) are frame synchronous. As they operate at high frequencies and where standardized for personal computers, they require much power and are not suitable for low power mobile devices. Sub-D, DVI and HDMI are defined for devices for which power consumption is not a concern.

Up to now there have been different approaches to provide small mobile devices having enhanced display capabilities: For example, it is possible to attach a TV set through analogue composite TV out of Nokia mobile phone N93. However, the resolution of a TV set is limited to PAL resolution (576×768 pixels), and DA-AD conversion wastes energy. The external TV display does not provide any significant improvement with respect to a conventional 320×240 pixels built-in display of the mobile phone, especially when considering the additionally required (De-) interlacing leading to further quality (comb-artifacts) and energy losses. Additionally, there is no other use possible through this interface.

Conventional video interfaces are designed for non-mobile operation, and the power consumption for providing a video data signal usually is too power-consuming for small mobile terminals.

Another restriction of conventional video interfaces resides in the fact that the video interfaces may only be used for a single task, Conventional video interfaces do not provide any versatile capabilities. Presently, there is only one possible solution to connect a small mobile telephone by using a bulky video interface using the conventional energy consuming 20, 50, 60 or 100 Hz frame signalization, with all the disadvantages with regard to operation time and/or required external power supply for the mobile phone. Even when considering that a mobile terminal may be equipped with a conventional interface, this does not provide any solution for the energy consuming signals required for these conventional interfaces. Additionally, the use of a conventional video interface has the drawback that the device may be connected to different conventional display devices, but these conventional interfaces also prescribe the signal to be used (and therefore, the power consumption required to generate this signal).

Presently, there is no video interface suitable for mobile terminals. For this reason there are presently no small mobile terminals that are provided with a video output interface to provide e.g. text and word processing capabilities.

There is still the trivial solution of using a proprietary video interface system, e.g. a kind of “mini Scart”, an “Ultra-Sub-D connector” or e.g. a “micro DVI”, or a “pico HDMI” interface. However, a proprietary video interface would require a respective proprietary display having a respective proprietary video input interface. This solution has the considerable drawback that the manufacturer has to provide the display device with an additional new proprietary connector and signal processing unit that may only be produced in low numbers. At the present time, there doesn't seem to exist a display interface, that is future-proof and fits to a mobile device such as a mobile telephone.

It is still desirable to have a mobile terminal device provided with a video interface allowing the use of applications with large visual requirements for operation.

It is also desirable to have a small, tiny terminal device having the capability of providing connectivity to video reproduction devices (to provide e.g. a recorded video data steam to a larger size visual output device such as a display).

It is also desirable to have a small portable terminal device capable of additionally providing the capability to execute programs with high visual requirements.

It is also desirable to provide small mobile terminals capable of providing an enhanced visual experience and enhanced image and display capabilities better than the requirements of a built-in display device.

According to one aspect of the present invention, a mobile terminal device having an enhanced video display interface for an external video display device is provided. The mobile terminal comprises a processing unit having the capability to process high resolution display content. The mobile terminal also comprises a user interface comprising at least a low resolution display. The user interface is connected to said processor to display low resolution video contents on said display with the native intrinsic “low resolution” of said display. The mobile terminal also comprises a video display interface connected to said processing unit, said video display interface having high resolution display contents transferring capabilities to provide said high resolution display contents from said processing unit. Said mobile terminal device is provided with high resolution display contents compression capabilities, to decrease the data content of said high resolution display contents. The high resolution display contents compression capabilities may be implemented as a dedicated circuit or as component or software unit in the processing unit. Said display interface is also provided with a serial bus connector to transfer said high resolution display contents having a reduced data rate to an external display device.

In a basic implementation the present invention may be embodied as a small portable player device capable of reproducing data (or executing applications using display content) on a small low resolution display. In accordance with the present invention this device may be connected to an external display device wherein the player device is capable of providing compressed display contents data to the external display device for high-resolution display. In a basic embodiment, the device of the present invention may be considered as a mobile player provided with capabilities to output compressed high resolution display content. In one embodiment, the device may be a gaming device such as a PSP™ (play station portable) capable of reproducing high resolution video data stored on a storage medium, having a low resolution display and a serial bus port for connecting a decompression enabled display device as a higher resolution display.

In an example embodiment, said high resolution display content compression circuit is capable of performing requested frame refresh, partial refresh, static masking and/or bit-block transfer (techniques). This capability may be achieved by dedicated said sub-circuits in the display content compression circuit or e.g. by a software program executed on the processing unit. By applying these data (rate) compression techniques it becomes possible to decrease the data rate or bandwidth required for the data transfer via a serial bus connector. It may be noted that the number of compression techniques required to decrease the data rate may be adapted to the resolution of the connected display. It is possible to select the display data compression device (or method) in accordance with the properties of the display data. It is, for example, possible to select partial frame refresh for display data in which only a part of said same comprises changing pixels. In case of completely static display contents (as may occur especially in the case of text processing [especially when comparing e.g. average typing speed with an average frame refresh cycle]), requested frame refresh may be the best way to decrease the bandwidth, which is required for the transfer of display data. The use of static masking- and bit-block transfer sub-circuits, programs or components is also especially useful in case of text and word processing applications running on the mobile terminal device. Static masking may be used to transfer mouse cursor, word or text blocks. Bit-block transfer may be used to transfer the graphic data of changing cursor designs and the like. The following paragraphs describe the compression techniques in more detail.

Requested refresh may be used if and when a display picture is not changed as often as the display is refreshed (e.g. 60 Hz). Hitherto interfaces with frame-synchronous transport (e.g.: ViSSI, Sub-D, HDMI) transport many identical pictures. A first simple, but efficient improvement is thus to monitor the existence of write-commands to the local frame buffer memory, for example by exploiting the electrical state of the Read-Not-Write (RNW) line. This is, e.g. a “0” until any application writes to the buffer. Then, it is “1” until the write access ends. This “1” means that one or more pixels of the image have changed, and that in the simplest case there is a (full) picture to be transported; otherwise the bus can go into power-down. The receiver only updates when a new picture is received.

Partial refresh is a further improvement achieved by Sub-Dividing the full display and frame buffer into equally sized blocks; and only the changed blocks are transported to the display including the appropriate xy-position offsets of the changed blocks. The size of these blocks can be optimized dependent on window sub-division of the display by the application, resolution and other properties. This is easily implemented by monitoring the frame-buffer address bus after a “Requested Refresh” event has been detected. This means that e.g. in a 16-bit address like XXXX XXXX XXXX XXXX and YYYY YYYY YYYY YYYY only a few bits (here 3 “X” and 3 “Y” bits) have to be extracted and transferred to conclude the display xy-position offset.

Static Masking is another additional improvement in order to (temporarily) define some parts of the display as e.g. background, which only extremely rarely change. This may be software defined and may exclude some of the “Partial Refresh” observed bits to further reduce power consumption. Another use case for static masking is the known Nokia “Partial Mode”, where only a fraction of the display is used to show the time and date. This is herein proposed to be also reflected in the external display interface.

Bit-Block Transfer (BitBLT) is a complex improvement. It comes into action, when a huge, but as such unchanged part of the display is “scrolled”. This happens typically during web-surfing or reading a longer document. It may also occur in slow panning movements of a camera. The detection can be realized autonomously by a block based autocorrelation circuit. This device compares a block of the old picture with the following picture aid derives a movement vector. In an alternative embodiment, the movement vector can directly be calculated from the input device, e.g. movement of the computer mouse used as the “hand”-tool (e.g. in Adobe Acrobat application), or scrolling in a window using the scroll bar with the mouse, or using the arrow keys of the keyboard. The preferred implementation is an API towards the phone display drivers which forwards the notification that such a movement had happened. The decoder can be implemented using a local memory to memory mover (a so called Blitter), but it should better be implemented by a small Memory Management Unit. This unit just holds a table containing the original physical memory address and shifts it to be shown at a new display address.

In contrast to e.g. MPEG or JPEG, these data reduction techniques are lossless. They are especially suited for computer applications in which only a part of the whole screen image is modified, e.g. by typing a letter in a text document or scrolling the page forward. These techniques allow an instantaneous reaction even with a very high resolution and a strictly bandwidth limited interface.

In yet another example embodiment of the present invention, said serial bus connector is a universal serial bus connector. By using widely accepted and used connectors, the price as for implementing the present invention may be kept low.

In just another example embodiment of the present invention, said universal serial bus connector is a mini universal serial bus connector. It is much simpler to provide a tiny mobile device with a mini USB connector than to find enough space to accommodate a standard USB connector or to find a space to accommodate one of the conventional video connectors. The mini USB connector may also be used to connect the device to a conventional computer to exchange, store or backup e.g. connection and address book data in the connected computer system.

In yet another example embodiment of the present invention, said processing unit is adapted to receive information related to the display capabilities of a connected display device via said serial bus, and is further configured to adapt the processing of high resolution display content to said received information.

It may be noted that the number of compression techniques required to decrease the data rate may be adapted to the resolution of the connected display. In the present embodiment e.g. information related to the display capabilities may comprise resolution and refresh cycle information. It is e.g. possible to select the display data compression (hardware or software) in accordance with the properties of the display data, e.g. it may be possible to completely economize the partial refresh, if the resolution and/or the refresh rate are low enough.

In still another example embodiment of the present invention, said mobile terminal is provided with a built-in camera connected to said processing unit. The camera may be a high resolution digital camera having a resolution of a few mega pixels. It is also possible that the camera is a video camera having at least VGA-resolution. It is also envisaged to implement a HD-resolution video camera in said mobile terminal device. The camera can use conventional image data information to transfer the image data to said processing unit.

In just another example embodiment of the present invention, said mobile terminal comprises a mobile telephone. The phone may be a GSM-phone or a UMTS-mobile phone.

This embodiment allows the use of the increasing computing power of modern mobile phones also in connection with applications requiring large displays such as video reproduction, text, word and graphic processing or CAD applications. When applied with a stereoscopic near eye display it may also be possible to show simple three dimensional structures using a mobile cell(ular) phone.

According to another aspect of the present invention, a mobile terminal device having an enhanced video display interface for connecting an external video display device is provided. This mobile terminal device comprises a processing unit having the capability to process display content using requested frame refresh, partial refresh, static masking and/or bit-block transfer (techniques). This mobile terminal device further comprises a user interface comprising a display connected to said processor unit in order to display video contents. The mobile terminal device further comprises a display interface connected to said processing unit in order to provide said display contents, wherein said display interface comprises a serial bus connector, especially a universal serial bus connector. The display of the mobile terminal device is capable of reproducing display contents compressed with requested frame refresh, partial refresh, static masking and/or bit-block transfer techniques.

The main difference to the mobile terminal device of the first aspect of the present invention described on the preceding paragraphs resides in a different kind of data processing that compresses also the data for the internal display, whereas in the device according to the first aspect only the signal to be sent to an external display is compressed. The mobile terminal of the present aspect uses the techniques of requested frame refresh, partial refresh, static masking and/or bit-block transfer techniques also for the built-in display. In this embodiment of the present invention it may be possible to increase the resolution only if a connected external display device is detected. This embodiment may serve to decrease the power consumption required to drive the built-in display of the mobile terminal device. Using the architecture of the second aspect of the present invention (and an internal display discarding the higher resolution components), it may be possible to use just a multiplexer and a respective queue to transform the compressed high-resolution display data into data transferable via the serial bus port such as e.g. an USB port.

In yet another example embodiment of the present invention, said serial bus connector is a universal serial bus (USB) connector. The USB connector is a widely used standard connector that is cheap, widely available and can also be used to connect the device to a conventional computer to exchanges store or backup e.g. connection and address book data in a computer system.

In just another example embodiment of the present invention, said universal serial bus connector is a mini universal serial bus connector. It is much simpler to provide a tiny mobile device with a mini USB connector than to find enough space to accommodate a standard USB connector or one of the conventional video connectors in a device of the size of e.g. approximately three matchboxes. The mini USB connector is a widely used standard connector that is cheap, widely available and can also be used to connect the device to a conventional computer to exchange, store or backup e.g. connection and address book data in a computer system.

In still another example embodiment of the present invention said processing unit is adapted to receive information related to the display capabilities of a connected display device via said serial bus, and is further configured to adapt the processing of high resolution display content to the said received information. It may be noted that the number of compression techniques required to decrease the data rate may be adapted to the resolution of the connected display. It is possible to select internal display data compression of the device in accordance with the properties of the display data of a connected display (or of a connected dongle). In case of the dongle, the dongle may use and/or forward any display information it receives, or the properties of a conventional video display interface may be used as display property information.

In still another example embodiment of the present invention, said mobile terminal is provided with a built-in camera, connected to said processing unit. The camera may be a high resolution digital camera having a resolution of a few mega pixels. It is also possible that the camera is a video camera having at least VGA-resolution. It is also envisaged to implement a HD-resolution video camera in said mobile terminal device. The (video) camera may use the above cited image data compressing technologies for image data preprocessing.

In just another example embodiment said mobile terminal comprises a mobile telephone. The phone may be GSM phone or a UMTS mobile phone. Such a mobile phone may be used if and when a display (and a keyboard having a cursor manipulation device such as a trackman) is connected as a complete word processing device. Such a phone may be used as a fully fledged large screen text processing device in near future, when used in combination with modern Bluetooth connectable foldable keyboards as user input interface.

According to another aspect of the present invention a dongle for interfacing between a mobile terminal device having an enhanced video display interface and an external video display device is provided. According to the present invention said dongle comprises a serial bus connector, a high resolution display contents decompression circuit and a conventional video interface. Said serial bus connector is provided to receive high resolution display contents with reduced data rate from a connected mobile terminal device. Said high resolution display contents decompression circuit is connected to said serial bus connector and is provided to convert said received high resolution display contents with reduced data rate to a standard video data stream. Said conventional video interface is connected to said high resolution display contents decompression circuit to output said (decompressed) standard video data stream. Said standard video stream may be sent via said conventional video interface to a conventional video data reproduction device such as a video display, a computer monitor, a TV-set, a high-density TV-set, a portable external surveillance screen or the like.

The dongle provides the “missing link” to connect the mobile terminal (or phone) of the present invention to a standard display device. Using the dongle of the present invention, it becomes possible to use e.g. a display of a standard PC computer (e.g. connected via a KVM [keyboard-video-mouse] switch) to display data of the mobile terminal in a high resolution format.

In an example embodiment of the present invention, said high resolution display contents decompression circuit is capable of performing requested frame refresh, partial refresh, static masking and/or bit-block transfer (techniques).

With these techniques (which may be implemented using specific sub-circuits or software) it is possible to decompress especially all the data received from of the mobile terminal devices described in the preceding description.

In another example embodiment of the present invention, said dongle is further provided with a high resolution display contents compression circuit, connected between said conventional video interface and said serial bus connector to receive a high resolution display contents via said conventional video interface and to convert said received high resolution display contents to a high resolution display contents having a reduced data rate to be sent via said serial bus connector. This embodiment extends the principle of the video or display data output from a mobile device to an external display device to an embodiment in which the dongle uses the display data compression techniques to transfer data to a connected mobile device. This dongle may be used to transfer data to the mobile terminal and to store short video contents on the mobile terminal. If and when a mobile terminal has e.g. a storage space of 1 to 10 GTB (what will happen with in the next 3 years . . . ) the dongle will provide a video recorder built into e.g. a mobile phone. To record a video, the user has to connect the terminal via the dongle to an AV (auxiliary video) port of the video (DVD and the like) player or TV device.

In yet another example embodiment of the present invention, said high resolution display contents compression circuit is capable of performing requested frame refresh, partial refresh, static masking and/or bit-block transfer (techniques). The features and effects are basically the same as already discussed in the preceding specification related to the different mobile terminal devices.

En yet another embodiment of the present invention said dongle is provided with a power supply. When using a dongle with an independent power supply, the operation time of a connected mobile terminal device may not be (significantly) reduced. A power supply in the dongle may be used to power or even charge the terminal device so that the operation time of the device is not reduced with respect to the normal operation time. It is also envisaged to power the dongle via the serial bus connection from the mobile terminal. It is also contemplated to use an external power supply for the dongle. Especially when considering that the expectedly large external display device is a non mobile device it may be expected that the dongle also can access a power line network (12/24V DC or 110/230V AC). Alternatively, the dongle contains a power supply connector, so that it can be connected to an outside power supply.

In just another additional example embodiment said serial bus connector is a universal serial bus (USB) connector.

In just another additional example embodiment said universal serial bus connector is a mini universal serial bus connector. The use of a mini USB connector enables a smaller implementation of the dongle. It is be possible to integrate the complete electronics and/or a wind up mechanism for the mini USB cable into the housing of a SCART video connector.

According to still another example embodiment of the present invention said dongle is further being provided with a storage device connected to said high resolution display contents decompression circuit to store received high resolution display contents.

The storage device can be connected to the USB video display interface and/or at the conventional video interface side of said high resolution display contents decompression circuit to store received high resolution display contents in either the high resolution display format or the high resolution display format with reduced data rate. It may also be possible that the storage device is capable of only storing high resolution display data or high resolution display data with reduced data rate. The storage device may be embodied as a DVD (HD-DVD or Blueraydisc) recorder, a solid state storage device recorder or e.g. as a hard-disk-drive (HDD) recorder. It is also envisaged that the storage device also provides media player capabilities to the dongle. In a very simple embodiment of the present invention, a simple dongle is built into a DVD (HDD) recorder, and the conventional video interface is hardwired to a video signal input terminal, and the dongle is also connected to the power supply of the DVD (HDD) recorder.

In yet another example embodiment of the present invention said dongle is also provided with a display connected to said high resolution display contents decompression circuit. This embodiment represents the bridge to a display device with a (e.g. universal) serial bus video data input interface. In a very simple embodiment of the present invention a simple dongle is built into a conventional display device, and the conventional video interface has been hardwired to a video signal input terminal of the display, and the dongle is also connected to the power supply of the display. in contrast to a simple display device, the “dongle display” is provided with a conventional video interface that may be used to output the decompressed video signal received via the (e.g. universal) serial bus connector (which is not necessarily the case in a pure serial bus video display device).

In still another example embodiment of the present invention said dongle is provided with a data provision unit to provide information related to the displaying capabilities of said conventional video interface via said serial bus connector. That is, the dongle can inform a device providing high resolution display contents via serial bus connection about the video processing capabilities of the dongle or of the conventional display interface properties (such as resolution, refresh cycles color depth and the like). These data may be transferred to the device providing high resolution display content signal with reduced data rate, to enable it to optimize the signal compression process. It may be expected that the dongle is only provided with a single conventional video interface with only a single expected signal quality so the use of a hard coded information storage may be sufficient. It may be expected that the dongle has a number of different conventional video interfaces with a plurality of possible output signals, which may require an evaluation circuit to determine which conventional video interface with which properties is actually used, to be able to transfer the correct information to the device providing the high resolution display content signal with reduced data rate.

According to another aspect of the present invention a display device for a mobile terminal device having an enhanced video display interface for connecting an external video source device is provided. Said display device comprises serial bus connector, a circuit capable of decompressing high resolution display contents and a display. The serial bus connector is provided to receive high resolution display contents having a decreased data rate from a connected mobile terminal device. The circuit capable of decompressing high resolution display contents is connected to said serial bus connector and is provided to convert received high resolution display contents having a decreased data rate to a standard video data stream/signal. The display device is provided with a display that is connected to said circuit capable of decompressing high resolution display contents to display said video data stream. It is expected that the display of the display device is capable of displaying in the standard video stream (such as VGA, TV signal or HD video signal) on an optical display area. The display device may also be a beamer (without a dedicated in-device display field).

Basically the display device may be embodied as a conventional monitor device provided with a built-in dongle as described in the preceding sections, wherein the conventional video output interface of the dongle is internally hardwired to the video signal input terminals of the display device. The display device of this aspect of the invention may be provided with a conventional video input (and maybe output) interface, but this is not crucial for the display device (as it still works without any additional external conventional video input interfaces).

In an example embodiment of the present invention, said high resolution display contents decompression circuit is capable of performing requested frame refresh, partial refresh, static masking and/or bit-block transfer.

In yet another example embodiment of the present invention, the display device further comprises a conventional video interface connected to said high resolution display contents decompression circuit to output said video data stream. The idea of this embodiment resides in providing an output interface in the display device to an external device recorder so that a decompressed video stream received from the mobile terminal can be to a conventional recording device, or to an additional conventional external display device. This embodiment can be used to store or record the display contents onto a video tape or DVD recorder connected to the display device in a standard data format. This implementation application may be used to record a video stream recorded with a camera in the mobile terminal and transferred via the display device onto a non-volatile memory device without using any computer devices, wherein the display device servers as the dongle of the preceding text. The conventional video interface may also be connected via a changeover switch to the display of the display device to enable the reproduction of a received conventional video stream on said display, which would enable the display device to display conventional video content received via the conventional video interface and (switched over) as a video output interface to an external device to output a decompressed video stream received as compressed display content via the bus connector from the mobile device.

In an embodiment of the present invention, said serial bus connector is a universal serial bus (USE) connector.

In an embodiment of the present invention, said universal serial bus connector is a mini universal serial bus connector. It may be noted that the universal serial bus connector may be embodied as an extensible USB connector cable, or as a USB socket to connect the mobile terminal device via a USB-USB connector cable. It may be envisaged to select different A/B connectors as built in plugs or sockets to prevent that these connectors are used for non compressed video applications. As in the case of the mobile terminal device it may also be possible to use the USB port for additional or alternative applications such as channel allocations, firmware updates, display usage restrictions (time channel and volume restrictions) of the display device. Different priorities for allocating USB bandwidth may be assigned in the case that the USB connection is shared among different applications. Connected USB devices may communicate their bandwidth requirements to the mobile terminal device. The mobile terminal device then allocates the bandwidth for these devices, taking also into account the application that uses the connected USB device.

In yet another embodiment of the present invention said display device is provided with a power supply. When using a display having an independent power supply the operation time of the mobile device may be extended. A power supply in the display device can be used to power or even charge the terminal device so that the operation time of the device is not reduced when used in connection with the display device. When the display device is provided with a built in battery it may be possible to use the mobile (telephone) terminal device as a completely mobile text processing system. The term text processing is also to be understood as encompassing an electronic book application. Especially when considering that the expectedly large external display device is a non-mobile device, it may be expected that the display device may be configured to access a power line network (12/24V DC (in vehicles) or 110/230V AC).

In still another example embodiment of the present invention, said display device is provided with a data provision unit to provide information related to the displaying capabilities of said built-in display via said serial bus connector. That is, the display device can transfer information concerning the resolution of the display via said serial bus connection to the mobile device providing said high resolution video display content with reduced data rate. These data may be transferred to enable the device to optimize the signal compression process. It may be expected that the display is only provided with a single display mode having only a single expected signal quality; therefore a hard-coded information storage may be sufficient to provide said information. It may be expected that the dongle has a number of different conventional video display modes (such as computer monitors) with a plurality of operation modes, which may require an evaluation circuit to determine which conventional display mode is actually selected, to be able to provide the correct information to the device providing the high resolution display content signal with reduced data rate.

In a further embodiment, the display communicates its display modes via the dongle to the mobile terminal. The display modes are communicated to the user via the display itself or via the low resolution display of the mobile terminal. The mobile terminal has a user input device to receive a user selection for any of the display modes, e.g. a keypad or a scroll wheel to browse through the display mode options. The mobile terminal then communicates the selected display mode to the dongle which outputs the video data on the conventional video interface at the selected resolution. Alternatively, the selected display mode is communicated directly to the display, if the display contains a circuit capable of the decompression according to the invention.

In another example embodiment of the present invention, said display device is a near eye display. That is, the display device is embodied as a goggle of spectacle monitor enabling in fully mobile use of a mobile terminal device for many different applications.

In the following, the invention will be described in detail by referring to the enclosed drawings in which:

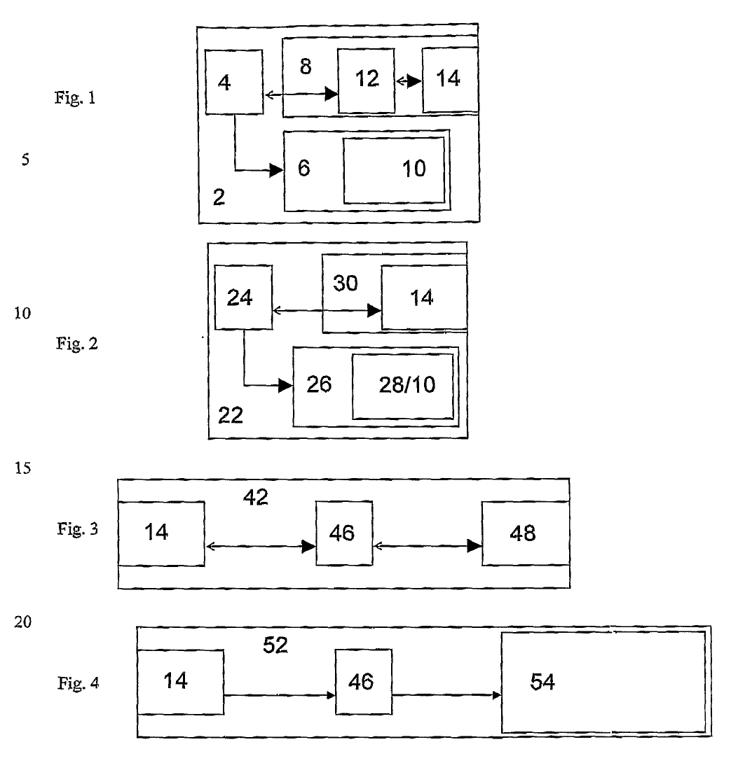

FIG. 1 is a schematic block diagram of a mobile terminal according to one aspect of the present invention,

FIG. 2 is a schematic block diagram of another mobile terminal according to another aspect of the present invention,

FIG. 3 is a schematic block diagram of a dongle for connecting one of said mobile terminal of FIG. 1 or 2 having a conventional display device,

FIG. 4 is a schematic block diagram of a display for connecting one of said mobile terminal of FIG. 1 or 2,

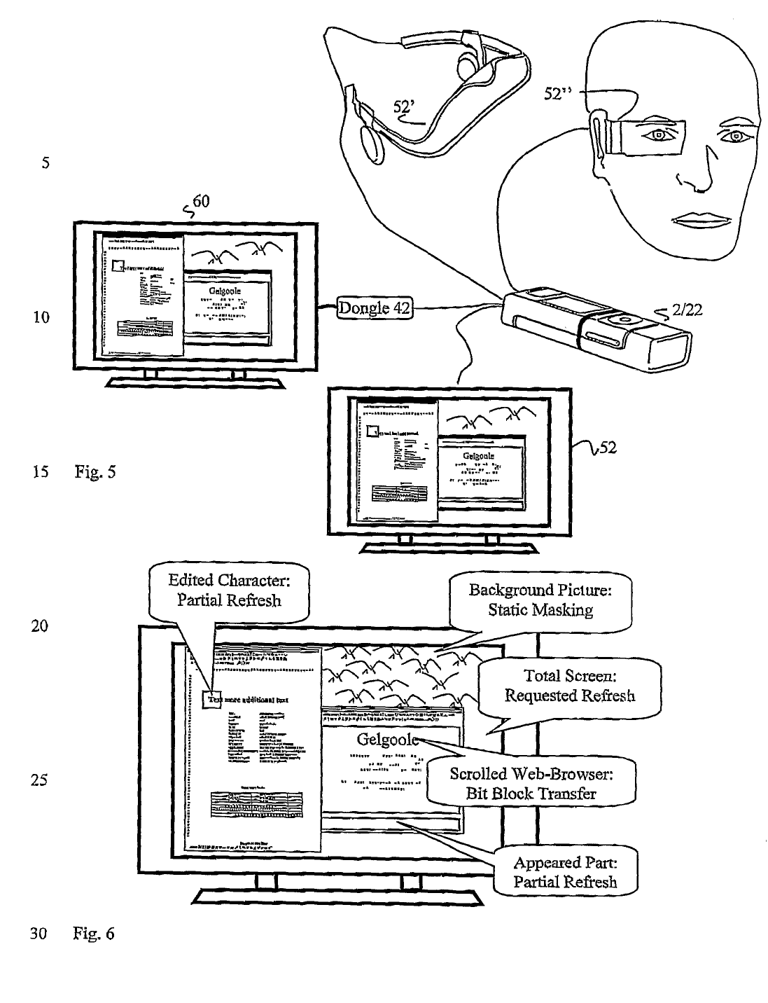

FIG. 5 is a schematic block diagram of a system of a small mobile terminal device connected via a USB interface to different high resolution display devices, and

FIG. 6 is a diagram showing the different aspects of display data compression on the example of the graphical interface of a browser and text processing application.

In the detailed description which follows identical components have been given the same reference numerals, regardless of whether they are shown in different embodiments of the present invention. In order to clearly and concisely illustrate the present invention, the drawings may not necessarily be to scale and certain features may be shown in somewhat schematic form.

FIG. 1 is a schematic block diagram of a mobile terminal according to one aspect of the present invention. The depicted mobile terminal device 2 comprises a processing unit 4, a user interface 6 having a low resolution display 10, a video display interface 8, wherein said terminal device has high resolution display contents compression capabilities provided by circuit 12 and a universal serial bus connector 14. The processing unit 4 has the capability to process high resolution display content, such as pictures, videos and graphic user interfaces of word and text processing applications. The user interface 6 comprises at least a low resolution display 10. The user interface 6 and the display 8 are connected to said processor unit 4 to display low resolution display contents. The display 8 is a display of a tiny mobile device and therefore low resolution display contents processing is sufficient according to the native “low resolution” of said built-in display.

The video display interface 8 or external video display interface 8, which is connected to said processing unit 4, is provided with high resolution display contents processing capabilities to provide high resolution display contents to an external display device. The video display interface 8 comprises the high resolution display contents compression capabilities provided by circuit 12 to decrease the data content (and therefore, the bandwidth requirement to transfer said display content) of said high resolution display contents. The high resolution display contents compression capabilities provided by circuit 12 may be provided with (not depicted) requested frame refresh sub-circuits, partial refresh sub-circuits, static masking sub-circuits and/or bit-block transfer sub-circuits. The video display interface 8 comprises also a universal serial bus (USB-) connector 14, to transfer said high resolution display contents having a decreased data rate to an external display device.

If the processing unit 4 has sufficient processing capabilities, it also performs the high resolution display contents compression, and circuit 12 is not needed.

FIG. 2 is a schematic block diagram of another mobile terminal 22 according to another aspect of the present invention. The mobile terminal device 22 having an enhanced video display interface for an external video display device also uses data compression for driving the built-in display. The mobile terminal device 22 comprises a processing unit 24 with capability to process compressed display content, wherein said processing unit comprises at least one sub-circuit selected from the group of requested frame refresh sub-circuits, partial refresh sub-circuits, static masking sub-circuits and a bit-block transfer sub-circuits. That is, a dedicated display data compression is not required for the interface to the external display device, as the data are processed in the device in a compressed format.

The mobile terminal device 22 also comprises a user interface 26 with a display 28 connected to said processor to display video contents. Said display is capable of displaying compressed display data provided by the processing unit 24 using requested frame refresh, partial refresh, static masking and/or bit-block transfer decompression techniques. It may be noted that the built user interface 26 with the display 28 of the mobile device may be provided with requested frame refresh sub-circuits, partial refresh sub-circuits, static masking sub-circuits and bit-block transfer sub-circuits to be capable of displaying said display content. This embodiment of a mobile terminal device employs display data compression for the data transfer between the processor unit and the built-in display.

The mobile terminal device 22 of FIG. 2 is also provided with a video display interface 30 for connecting an external display connected to said processing unit 22 to provide said compressed display contents to an external display device (not depicted), wherein said video display interface 30 comprises a universal serial bus connector 14.

A user may not detect any differences between the terminal devices of FIGS. 1 and 2, as may not be perceived by an average user, as the display, the user interface and the signals that may be sent to an external display are the same.

The present invention may be used to implement an office PC in a mobile device as small as a pocket mobile phone, e.g. a mobile phone may serve as a personal mobile office pocket PC (Personal computer). With the present invention it may become possible to make PCs and notebooks obsolete, as the processing power of modern mobile phones is sufficient to provide all office applications in a mobile device. The only restriction resides in the limited display capabilities which may be overcome with the present invention.

The present invention solves the display restrictions of modern mobile devices by connecting the terminal device to an appropriate external USB interconnectable display. The present invention uses USB as direct video display interface for mobile devices and mobile phones instead of certain existing video display interfaces. The use of USES becomes possible by circumventing the typical 60 Frames per second display refresh rate which requires a high continuous data rate (bandwidth) and leads thus to unacceptable power consumption.

USB 2.0 standard compliancy may be achieved by a proprietary device by using the existing standardized USB Video Class transfer protocol using “USB 2.0 high speed” and extending e.g. the “Vendor Defined payload field”. If a non-Nokia device is connected, than the USB interface is still usable but requires significant more power.

This power saving is achieved by hardware and software improvements. The following set can be partly or fully used to obtain an obvious difference in “Phone as Notebook” like use cases. This is word processing, web browsing, personal information management applications (calendar, phonebook, address book . . . ), etc. Data compression techniques such as requested refresh, partial refresh, static masking, and bit-block transfer may be employed to decrease the data/bit-rate of the display contents signal.

Using these very simple display data compression techniques in connection with an USB standard (even USB 1.1 Full Speed with 12 Mega Bit per second would be fast enough) allows a typical phone to run a huge external display for desktop PCs with a typical office application employing high resolutions (e.g. UXGA, 1600×1200) in a very power efficient way to form a truly “Mobile Office”. Office applications may comprise word processing programs, spread sheets, E-Mail and calendar programs, presentation programs, time planning and scheduling programs or drawing programs. The invention is also useful for other applications like internet browsing, navigation programs, or image viewing or image editing programs. For these programs a high data rate reduction can be achieved by the data compression techniques, as image content changes typically at a much lower rate as normal frame refresh rates of displays, or as only a small part of the whole image is changed at a time.

USB provides also easy to use, ubiquitous available and flexible extensions such as: chargers, external HDDs, keyboards, printers and the like. “USB 3.0 Advanced Speed” will be backward compatible with all existing USE 2.0 devices. Both suggested typical usage solutions require the following implementations: Using existing standardized “USB Video Class—UVC” with USB 2.0 HS, in connection with resolutions up to 800×600 pixels (or even a little higher when accepting other restrictions).

FIG. 3 is a schematic block diagram of a dongle 42 for connecting one of said mobile terminal of FIG. 1 or 2 to a conventional display device. The dongle comprises a universal serial bus (USB) connector 14 to receive high resolution display contents having a reduced data rate from a connected mobile terminal device. The USB connector 14 is connected to a high resolution display contents decompression circuit 46. The high resolution display contents decompression circuit 46 is provided to convert said received high resolution display contents having reduced data rate to a standard video data stream. It may be noted that the high resolution display contents decompression circuit 46 may be configured to generate video streams according to different video stream standards (such as MD standard, PAL, VGA, SECAM (Séquentiel couleur à mémoire), NTSC or the like). The high resolution display contents decompression circuit 46 is connected to at least one conventional video interface 48 to provide the standard video data stream to an external conventional display device (not depicted). As in the case of above described terminal devices, the high resolution display contents decompression circuit 46 may be provided with dedicated requested frame refresh decoding sub-circuits, partial refresh decoding sub-circuits, static masking decoding sub-circuits and a bit-block decoding transfer sub-circuits to be capable of converting the received high resolution display contents with reduced data rate to a conventional standard video stream.

The dongle may be used to employ existing consumer devices such as TV set, a monitor or a beamer for sharing a common presentation. The incompatibility between mini USB and Sub-D or DVI can be bridged by a USB-dongle before a compatible USB display device solution is available. A huge display (TV set, TFT (Thin Film Transistor), Plasma) which exists at many homes can be accessed by e.g. HDMI. In this case the dongle is basically a USB/HDMI converter. The dongle solution may or may not be mobile, but presents a cheap and fast way to provide a wide usability even in an environment without any USB video display interfaces.

FIG. 4 is a schematic block diagram of a display device for directly connecting to one of said mobile terminal of FIG. 1 or 2. The display device 52 may be embodied as a conventional display device provided with a built-in dongle of FIG. 3. The display device 52 for a mobile terminal device (having an enhanced video display interface for an external video display device) comprises a universal serial bus (USB) connector 14 to receive high resolution display contents having a reduced data rate from a connected mobile terminal device (as e.g. depicted in FIG. 1 or 2). The USB connector 14 is connected to a high resolution display contents decompression circuit 46 connected to said universal serial bus connector 14.

The high resolution display contents decompression circuit 46 is provided to convert said received high resolution display contents with reduced data rate to a standard video data stream that is forwarded to the high resolution display 54 of the display device 52.

The display device may be implemented as virtually goggles in a fully mobile system (as depicted in FIG. 5 reference sign 52′) or as a virtual near to eye display (see FIG. 5 reference sign 52″), which can be worn like conventional spectacles. Head worn display devices can be optionally powered via the USB connection by the phone battery. Therefore, no additional battery carried behind the ear is required. Here it is crucial that the power consumption of the whole system is very low. The required low power consumption may not be achieved with video interfaces like DVI or HDMI. The power consumption required for a USB interface is sufficiently low to implement a fully mobile implementation.

The display device may be implemented as a binocular near eye display enhancement to mobile terminals. The display contents are provided by a mobile terminal and both devices are connected via e.g. USB. Thus the near eye display can be seen as the next step visualization device solving the problem of too small screen sizes in the mobile terminal and in a mobile application.

FIG. 5 is a schematic block diagram of a system of a small mobile terminal device connected via a USB interface to different high resolution display devices: The tiny mobile phone 2/22 is depicted having the housing of a Nokia 7280 mobile telephone. The mobile terminal is provided with a USB connection to different external display device such as a conventional stationary huge HD-Ready plasma TV 60, which is connected via a signal conversion dongle to convert the compressed display contents data provides by the mobile (telephone) device to a video data stream, the conventional HD-Ready plasma TV may use as video signal input.

The mobile terminal is provided with a USB connection to connect to display devices with dedicated USB display data/signal input interfaces. FIG. 5 shows a HD plasma TV 52 having a USB video display interface binocular display goggles 52′ and a monocular near eye head up display device 52′.

The devices 52, 52′ and 52″ are capable of directly displaying compressed display contents data provided by the mobile (telephone) device on the displaying component. Conversion to a video data stream may take place internal of the devices.

It may be noted that the mobile terminal device may be provided with a number of USB connectors. It may also be noted that the mobile terminal device may use the USB connector to connect the terminal device also to other external components such as user interfaces (keyboards keypads, mice, trackball devices) or external devices such as cameras, printers or external memory devices (USB Sticks, hard disc drives . . . ).

FIG. 6 is a diagram showing the different aspects of display data compression on the example of the graphical interface of a browser and text processing application. In the Figure it is indicated which portions of a display contents may be compressed using which of the compression techniques.

Requested refresh may be used if and when a display picture is not changed as often as the display is refreshed (e.g. 60 Hz). When considering e.g. word processing application a typing frequency of 1000 key inputs per minute (present world record) results in a reduction of frame rate by a factor of 3.6. When considering typing frequency of a few hundreds of key strokes per minute the reduction of the frame rate becomes even more significant.

Partial refresh is a further improvement achieved by subdividing the fall display and frame buffer into blocks of equal size or different sizes and transport only the changed blocks including the appropriate xy-position offset or a block number. The size of these blocks can be optimized dependant on resolution and other properties. This is easily implemented by monitoring the frame-buffer address bus after a “Requested Refresh” event has been detected. This means that e.g. in a 16-bit address like XXXX XXXX XXXX XXXX and YYYY YYYY YYYY YYYY only a few bits (here 3 “X” and 3 “Y” bits) have to be extracted and transferred to know the display xy-position offset.

Static masking is another additional improvement to (temporarily) define some parts of the display as e.g. background, which changes only rarely. This may be software defined and may exclude some of the “Partial Refresh” observed bits to further reduce power consumption.

Bit-block transfer is a complex improvement. It comes into action, when a huge, but itself unchanged part of the display is “scrolled”.

The techniques are lossless and especially suited for computer applications in which only a part of the whole screen image is modified, e.g. by typing a letter in a text document or scrolling the page forward. These techniques allow an instantaneous reaction even in circumstances with a very high resolution and a strictly bandwidth limited video display interface.

With the present invention it becomes possible to run e.g. an office application e.g. on a mobile device and connect it to an external display for better viewing, without the restriction of the low resolution display data processing of an internal display being used for driving the external display device. The present invention enables the use of an external higher resolution display in a mobile device without the powerful architecture having higher processing power and bus bandwidth for supplying the data needed for a constant refresh (e.g. at 30 frames/second) of the image. The present invention avoids high power consumption rates caused due to e.g. high bus toggle rates, which would be detrimental with respect to usage time of a battery powered device.

The present invention solves the contradicting user desires for huge display size and tiny mobile devices (e.g. phone package size). Users want small and shrinking mobile devices with increasing processing power, but not un-ergonomic small screens and user interfaces. The present invention provides a broadband interface to the human eyes (nearly) as powerful as the broadband interface “optic nerve” as the available “maximal broadband” interface from the human eye to the human brain. By overcoming the display restrictions of tiny mobile phone) devices the most obvious gap between a PC and a phone may be overcome.

It may be noted that in the specification, some components usually present in mobile terminal devices have been economized for not obscuring the description of the present invention. Standard components such as user input interfaces (i.e. scroll-wheels, buttons, keyboards, keypads, touch screens, trackballs and the like), telephone components (such as RF stages, SIM-card trays, RF communication technology), audio processing components (storage, player, media and sound processing components), storage and dedicated processing components (CPUs, non volatile memories, RAMs and hard disc drives, and the like) as well as additional interfaces (audio, stereo connectors, Bluetooth- or IR-interfaces for connecting additional user input interfaces (e.g. keyboards)) are not described here in detail as it should be clear that and how additional components may be integrated in or connected to the devices of the present invention.

With the present invention it is possible to add a large desktop as graphical user interface (display) to a small mobile telephone. The connection to a large size display may be implemented with plug and playability. With the present invention it is possible to provide a small phone with a huge (external) desktop. With the present invention even HD-Ready video with a resolution of 1280×720, 1920×1008) becomes feasible with mobile terminals such as mobile cellular telephones. The application may be compatible to future USB standards and connectors. The present invention may be implemented in a first step with a very low impact and than may be gradually be extended to support more efficient solutions for HD-Ready terminals and future devices. The invention opens up a fully new mobile-centric eco-space with high resolution mobile applications such as a personal avatar, augmented reality street guides and the like.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. Apparatus comprising:
a processing unit having the capability to process high resolution display content,
a user interface comprising at least a low resolution display, connected to said processing unit to display low resolution display contents, and
a video display interface connected to said processing unit, said video display interface having high resolution display contents transferring capabilities to provide said high resolution display contents from said processing unit, wherein
said processing unit comprises compression capabilities of high resolution display contents to reduce the data rate of said high resolution display contents,
wherein said compression capabilities comprises performing at least one compression selected from the group of requested frame refresh, partial refresh, static masking and/or bit-block transfer, and
a serial bus connector is provided to transfer said high resolution display contents having a reduced data rate to an external display device.

2. (canceled)

3. Apparatus according to claim 1, wherein said serial bus connector is a universal serial bus connector or a mini universal serial bus connector.

4. (canceled)

5. Apparatus according to claim 1, wherein said processing unit is configured to receive information related to the display capabilities of a connected display device via said serial bus connector, and is further configured to adapt the processing of high resolution display content to the received information.

6. Apparatus according to claim 1, wherein said apparatus comprises a built-in (video/digital) camera connected to said processing unit and/or a mobile telephone.

7. (canceled)

8. Apparatus comprising:
a processing unit having a capability to process high resolution display content, and the capability of using requested frame refresh, partial refresh, static masking and transfer, for providing said high resolution display content with a reduced data rate,
a user interface comprising a display, connected to said processing unit to display video contents, and
a video display interface connected to said processing unit to provide said high resolution display contents with reduced data rate, wherein said video display interface comprises a serial bus connector.

9. Apparatus according to claim 8, wherein said serial bus connector is a universal serial bus connector or a mini universal serial bus connector.

10. (canceled)

11. Apparatus according to claim 8, wherein said processing unit is configured to receive information related to the display capabilities of a connected display device via said serial bus connector, and is further configured to adapt the processing of high resolution display content to the received information.

12. Apparatus according to claim 8, further comprising a built-in (video/digital) camera and/or a mobile telephone, connected to said processing unit.

13. (canceled)

14. Apparatus comprising:
a serial bus connector to receive high resolution display contents having a reduced data rate from a device connected via an enhanced video display interface,
a high resolution display contents decompression circuit connected to said serial bus connector to convert said received high resolution display contents having a reduced data rate to a standard video data stream, wherein said high resolution display contents decompression circuit is capable of performing requested frame refresh, partial refresh static masking and/or bit-block transfer and
a conventional video interface connected to said high resolution display contents decompression circuit to output said standard video data stream.

15. (canceled)

16. Apparatus according to claim 14, further comprising
a high resolution display contents compression circuit connected between said conventional video interface and said serial bus connector to receive a high resolution display contents via said conventional video interface and to convert said received high resolution display contents to a high resolution display contents having a reduced data rate to be sent via said serial bus connector wherein, said high resolution display contents compression circuit is capable of performing requested frame refresh, partial refresh, static masking and/or bit-block transfer.

17. (canceled)

18. Apparatus according to claim 14, further comprising a connector for a power supply, and/or wherein said serial bus connector is a universal serial bus connector or is a mini universal serial bus connector.

19-20. (canceled)

21. Apparatus according to claim 14, further being provided with a storage device connected to said high resolution display contents decompression circuit to store received high resolution display contents, and/or further being provided with a display connected to said high resolution display contents decompression circuit, and/or is further provided with a data provision unit to provide information related to the displaying capabilities of said conventional video interface via said serial bus connector.

22-23. (canceled)

24. Apparatus comprising:
a serial bus connector to receive high resolution display contents having a reduced data rate from a connected device,
a circuit capable of high resolution display contents decompression connected to said serial bus connector to convert said received high resolution display contents having a reduced data rate to a standard video data stream, wherein said high resolution display contents decompression circuit is capable of performing requested frame refresh, partial refresh, static masking and/or bit-block transfer decoding, and
a display connected to said high resolution display contents decompression circuit to display said video display data stream.

25. (canceled)

26. Apparatus according to claim 24, further comprising a conventional video interface connected to said high resolution display contents decompression circuit to output said video display data stream, and/or said serial bus connector is a universal serial bus connector and/or said serial bus connector is a mini universal serial bus connector, and/or said display comprises a power supply.

27-29. (canceled)

30. Apparatus according to claim 24, wherein said display is a near eye display, and/or wherein said display is provided with a data provision unit to provide information related to the displaying capabilities of said display via said serial bus connector.

31. (canceled)

32. Apparatus according to claim 5, wherein said apparatus comprises a built-in (video/digital) camera connected to said processing unit and/or a mobile telephone.

33. Apparatus according to claim 11, further comprising a built-in (video/digital) camera and/or a mobile telephone, connected to said processing unit.

34. Apparatus according to claim 16, further being provided with a storage device connected to said high resolution display contents decompression circuit to store received high resolution display contents, and/or further being provided with a display connected to said high resolution display contents decompression circuit, and/or is further provided with a data provision unit to provide information related to the displaying capabilities of said conventional video interface via said serial bus connector.
